(19) United States
(12) Patent Application Publication
(10) Pub. No.: US 2010/0124697 A1
(43) Pub. Date: May 20, 2010

(54) BATTERY COVER MECHANISM

(75) Inventors: Rui-Hao CHEN, Shenzhen City (CN); Zhi-Yang LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/567,909

(22) Filed: Sep. 28, 2009

(30) Foreign Application Priority Data
Nov. 14, 2008 (CN) 200810305557.0

(51) Int. Cl. H01M 2/10

(52) U.S. Cl. 429/97

(57) ABSTRACT

A battery cover mechanism includes a housing and a cover engageable with the housing, the housing has two sliding grooves defined at two sides thereof and a plurality of latching holes at an end thereof. The cover forms rails at the two sides thereof to engage with the sliding grooves accordingly and a plurality of latches at an end thereof to latch into the latching holes of the housing correspondingly. The housing forms at least a stopping slot, the cover forms at least a stopping body, the stopping body is slidably received in the stopping slot and cannot slide out from the stopping slot.

### BACKGROUND

1. Field of the Invention

The present disclosure relates to battery cover mechanisms, particularly to a battery cover mechanism used in portable electronic devices.

2. Description of Related Art

Portable electronic devices such as mobile phones and personal digital assistants (PDAs) are widely used. When a battery is installed in the portable electronic device, the battery is generally shielded and fixed in place by a battery cover mechanism.

A typical battery cover mechanism includes a cover and a housing. The cover includes a pin at one end and a protrusion at an opposite end. The housing defines a receiving hole and a holding aperture. The protrusion can be received into the holding aperture, and the cover can be impelled towards the housing until the pin is received into the receiving hole. As such, the cover securely engages with the housing. However, the cover usually needs to be detached from the housing for removing a battery from the housing, thus cover may subject to being lost or misplaced.

Therefore, there is room for improvement within the art.

### BRIEF DESCRIPTION OF THE DRAWINGS

Many aspects of the present battery cover mechanism can be better understood with reference to the following drawings. The components in the various drawings are not necessarily drawn to scale, the emphasis instead being placed upon clearly illustrating the principles of the present battery cover mechanism. Moreover, in the drawings, like reference numerals designate corresponding parts throughout the diagrams.

FIG. 1 is a disassembled top view of the battery cover mechanism, according to an exemplary embodiment.

FIG. 2 is a disassembled bottom view of the battery cover mechanism shown in FIG. 1.

FIG. 3 is an assembled and partially sectional schematic view of the battery cover mechanism shown in FIG. 1.

FIG. 4 is a schematic view of the cover closed relative to the housing.

FIG. 5 is a sectional schematic view along the line V-V shown in FIG. 4.

FIG. 6 is a sectional schematic view in opening of the cover shown in FIG. 4.

### DETAILED DESCRIPTION OF THE EMBODIMENT

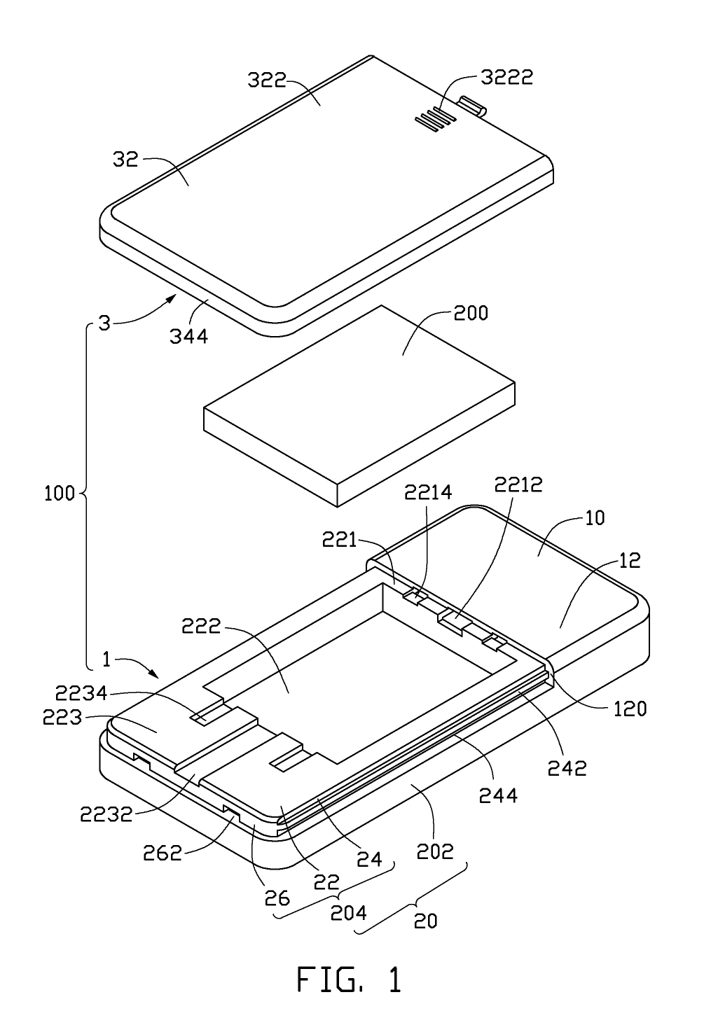

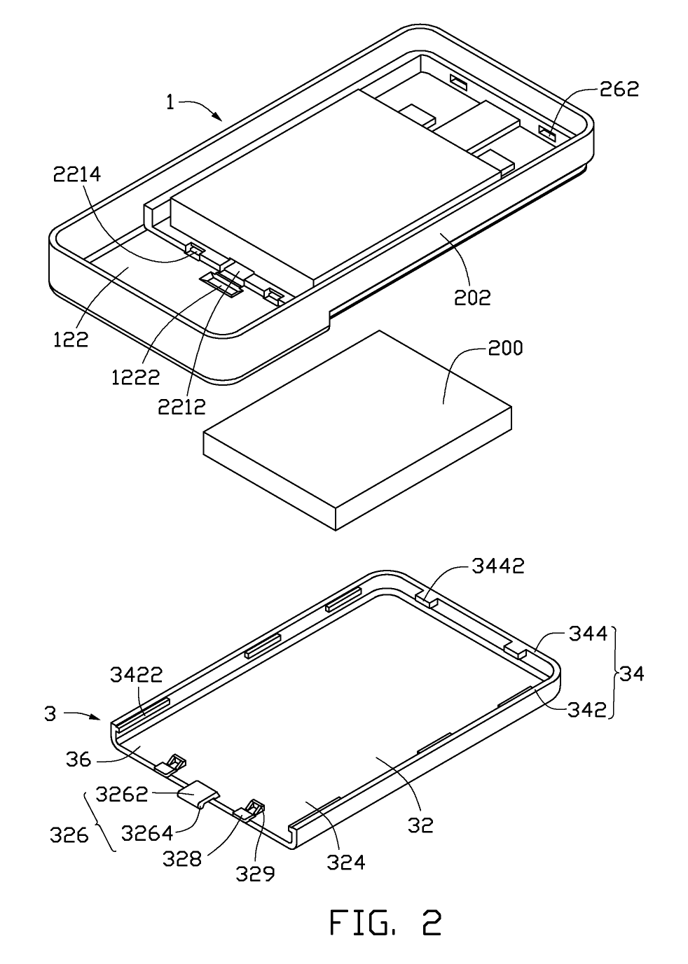

Referring to FIGS. 1 and 2, the battery cover mechanism 100 can be used in mobile phones, and can also used in other portable electronic devices, such as personal digital assistants (PDAs), digital cameras, etc. The battery cover mechanism 100 includes a housing 1 and a cover 3 detachably secured to the housing 1.

The housing 1 includes a first portion 10 and a second portion 20 connecting with the first portion 10. The second portion 20 is lower than the first portion 10, forming a step wall 120 between the first portion 10 and the second portion 20. The second portion 20 includes a seat portion 202 and a protrusion portion 204 protruding from the seat portion 202. The protrusion portion 204 is engageable with the cover 3 and includes a top wall 22, two sidewalls 24 and an end wall 26. The top wall 22 defines a receiving cavity 222 adjacent to the first portion 10, correspondingly forms a first partition stage 221 abutting the step wall 120 and a second partition stage 223 opposite to the first partition stage 221. The receiving cavity 222 receives a battery 200. The first partition stage 221 defines a first latching slot 2212 and two second latching slots 2214 at two sides of the first latching slot 2212. The first latching slot 2212 and the second latching slots 2214 are used to latch with the cover 3 and extend longitudinally into the step wall 120. The second partition stage 223 forms an assembling slot 2232 and two stopping slots 2234. The stopping slots 2234 are located at two sides of the assembling slot 2232. The assembling slot 2232 aligns with the first latching slot 2212, extends through the end wall 26, and communicates with the receiving cavity 222. Each of the two stopping slots 2234 is parallel with the assembling slot 2232 and aligns with the respective second latching slot 2214. The stopping slots 2234 extend to the receiving cavity 222 and retain the cover 3.

The two sidewalls 24 protrude laterally from two flanges 242. The flanges 242 extend along the sidewall 24, and thus define two guiding grooves 244 of the protrusion portion 204. The end wall 26 defines two latching holes 262 to latch with the cover 3.

Referring further to FIG. 1, the first portion 10 includes a first main plate 12. The first main plate 12 has an internal surface 122 (FIG. 2). A holding cavity 1222 is defined in the internal surface 122. The holding cavity 1222 aligns and communicates the first latching slot 2212.

The cover 3 includes a second main plate 32 and a peripheral wall 34. The peripheral wall 34 protrude perpendicularly from the edge of the second main plate 32 and enclose an opening 36 exposed at an end of the second main plate 32. The second main plate 32 has an outer surface 322 and an inner surface 324. The outer surface 322 has a plurality of strips 3222, allowing a manual manipulation of the cover 3. The inner surface 324 forms a first latch 326 and two second latches 328. The second latches 328 are positioned at two sides of the first latch 326. The first latch 326 and the second latches 328 extend from the opening 36 to outside and are parallel with each other. The first latch 326 latches into the first latching slot 2212 and includes a plate portion 3262 and a hook portion 3264 at the tail of the plate portion 3262. The plate portion 3262 can pass through the first latching slot 2212 and the hook portion 3264 latches into the holding cavity 1222. The second latches 328 latch into the second latching slots 2212. The inner surface 324 has two stopping bodies 329 formed align and abut the second latches 328, respectively. The stopping body 329 is wedge-shaped and engages into the stopping slot 2234.

The peripheral wall 34 includes two parallel side flanges 342 and a connecting flange 344 connecting the two side flanges 342. The connecting flange 344 is opposite to the opening 36. The side flange 342 forms a plurality of rails 3422 on the inside surface. The rails 3422 are arranged in a line and slidably engage into the guiding groove 244. The connecting flange 344 forms two latching blocks 3442 on the inside surface, facing the opening 36. The latching blocks 3442 are engageable with the latching holes 262 of the housing 1.

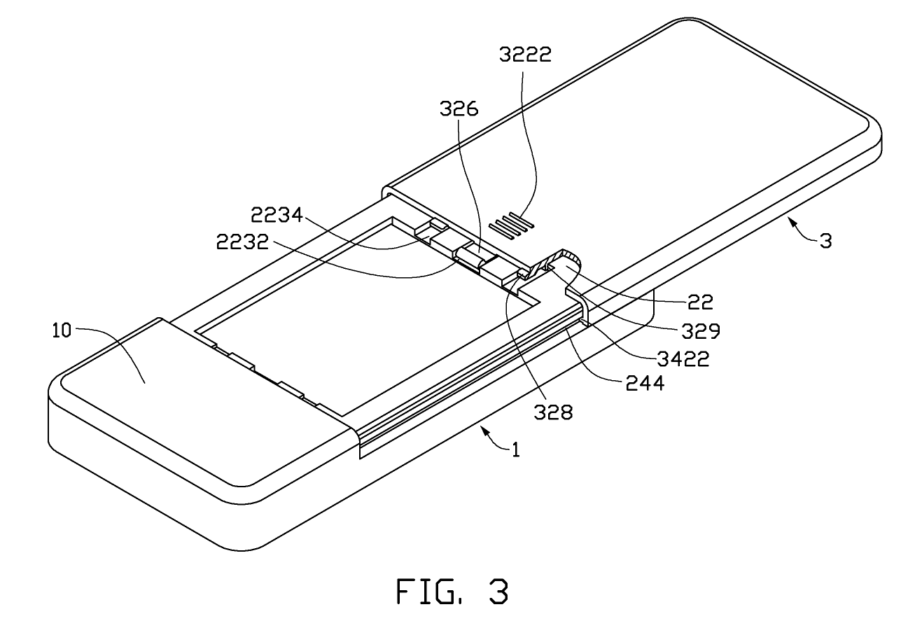

Referring to FIG. 3, to assemble the battery cover mechanism 100, the cover 3 engages the protrusion portion 204 of the second portion 20. The opening 36 is aligned above the second partition stage 223 of the housing 1. The first latch 326 is received in the first latching slot 2212, the rails 3422 are aligned with the guiding groove 244. The cover 3 is pushed toward the first portion 10, and the stopping bodies 329 resist against the top wall 22 of the protrusion portion 204. The stopping bodies 329 slide into the stopping slots 2234, overcoming the friction force of the stopping bodies 329 and the top wall 22. The cover 3 is assembled in the housing 1 and cannot detach from the housing 1 due to the engagement of the stopping bodies 329 into the stopping slots 2234.

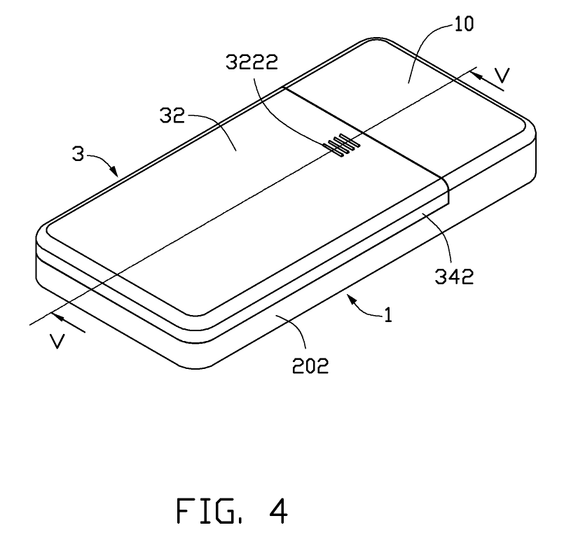

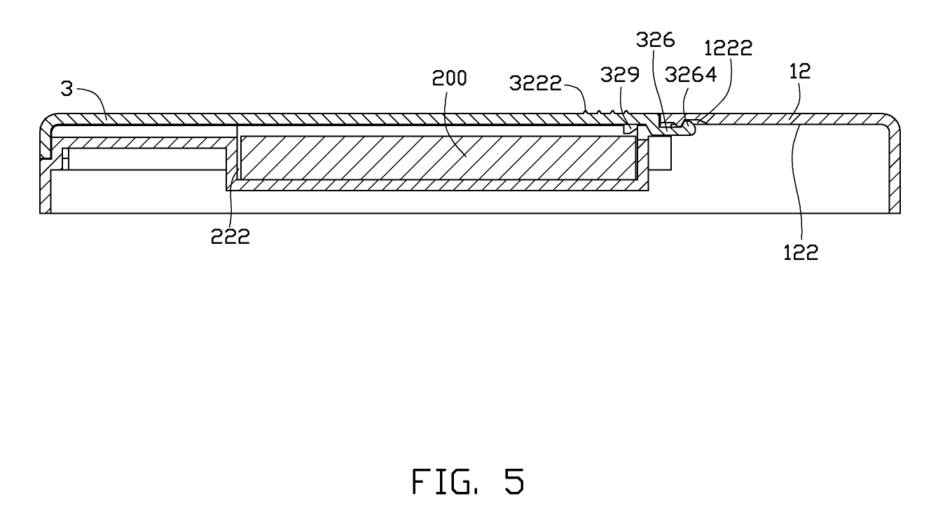

Referring to FIGS. 4 and 5, after the battery 200 is placed into the receiving cavity 222. The cover 3 is pushed toward the first portion 10. When the first latch 326 is inserted into the first latching slot 2212, the plate portion 3262 of the first latch 326 passes through the first latching slot 2212 and the hook portion 3264 latches into the holding cavity 1222 of the first portion 10. The second latches 328 are latched with the second latching slots 2212 respectively. Meanwhile, the two latching blocks 3442 of the cover 3 are latched into the two latching holes 262 of the protrusion portion 204. Thus, the battery 200 is secured to the receiving cavity 222.

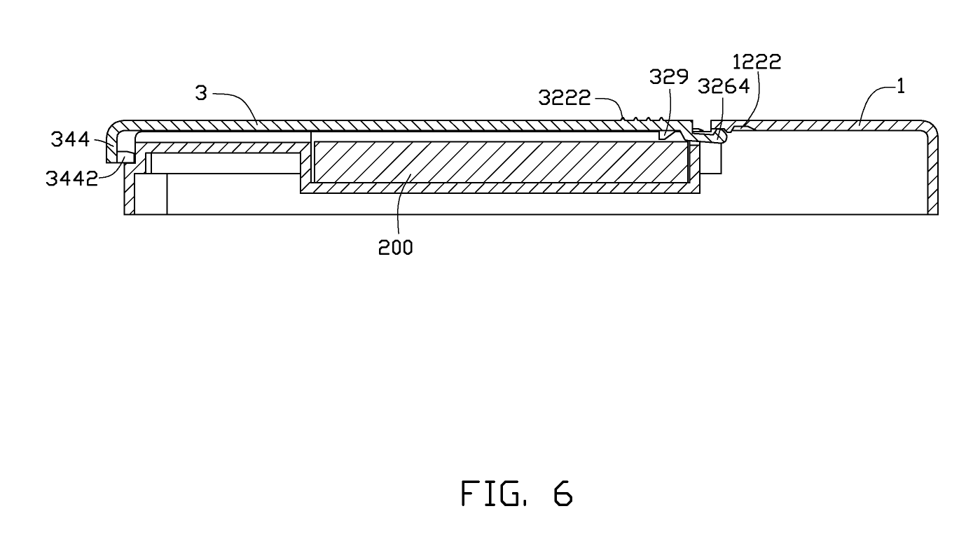

Referring to FIG. 6, to take out the battery 200, the cover 3 can be slid towards the second portion 20 by impelling the strips 3222. The hook portion 3264 of the first latch 326 disengage from the holding cavity 1222 and the first latch 326 releases out of the first latching slot 2212. The second latches 328 extract from the second latching slots 2212. Accordingly, the two latching blocks 3442 detach away from the two latching holes 262. The cover 3 slide until the stopping bodies 329 resist an end wall of the stopping slots 2234. At the time, the cover 3 can completely expose the battery 200 for an easy removal out from the receiving cavity 222. The cover 3 is still attached to the housing 1.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A battery cover mechanism for a portable electronic device, comprising:
a housing having two sliding grooves defined at two sides thereof and at least one latching hole defined at an end thereof;
a cover having at least two rails formed at the two sides thereof to engage with the sliding grooves respectively and at least one latch formed at an end thereof to latch into the latching holes of the housing correspondingly;
wherein the housing forms at least one stopping slot, the cover forms at least one stopping body, the stopping body is slidably received in the stopping slot to retain the cover attaching with the housing.

2. The battery cover mechanism as claimed in claim 1, wherein the housing includes a first portion and a second portion, the first portion connects with the second portion and forms a step wall.

3. The battery cover mechanism as claimed in claim 2, wherein the second portion includes a seat portion and a protrusion portion protruding from the seat portion, the protrusion portion includes a top wall, two sidewalls and an end wall, the top wall defines a receiving cavity to receive a battery.

4. The battery cover mechanism as claimed in claim 3, wherein the top wall forms a first partition stage and a second partition stage at two sides of the receiving cavity, the first partition stage defines a first latching slot and two second latching slots, the first latching slot and the second latching slots extend longitudinally into the step wall and communicate with the receiving cavity.

5. The battery cover mechanism as claimed in claim 4, wherein the second partition stage forms an assembling slot and two stopping slots at two sides of the assembling slot, the assembling slot aligns with the first latching hole and communicates the receiving cavity to end wall, the stopping slot correspondingly aligns with the second latching hole and extends into the receiving cavity.

6. The battery cover mechanism as claimed in claim 3, wherein the protrusion portion includes two sidewalls, each sidewall protrudes a flange extending along the sidewall and forms the groove slot.

7. The battery cover mechanism as claimed in claim 3, wherein the end wall defines two latching holes, the cover forms two latching blocks, the latching blocks correspondingly latch into the latching holes.

8. The battery cover mechanism as claimed in claim 4, wherein the cover includes a main plate and a peripheral wall, the peripheral wall protrude perpendicularly around the edge of main plate and enclose an opening.

9. The battery cover mechanism as claimed in claim 8, wherein the main plate forms a plurality of latches in the inner surface and the latches extend parallelly from the opening to outside.

10. The battery cover mechanism as claimed in claim 8, wherein the latches includes a first latch and two second latches, the first latch latches into the first latching slot, and the second latches correspondingly latch into the second latching slots.

11. The battery cover mechanism as claimed in claim 10, wherein the first latch includes a plate portion and a hook portion at the tail of the plate portion, the housing defines a holding cavity aligning with the first latching slot, the plate portion pass through the first latching slot and the hook portion latches into the holding cavity.

12. The battery cover mechanism as claimed in claim 10, wherein the main plate forms two stopping bodies aligning with the two second latches respectively, each stopping body is wedge shape.

13. The battery cover mechanism as claimed in claim 8, wherein the peripheral wall includes two side flanges, each side flange forms a plurality of rails arranged in a line to engage with the guiding groove.

14. A battery cover mechanism for a portable electronic device, comprising:
a housing having a first portion and a second portion, the first portion having a plurality of latching holes defined, the second portion having two sliding grooves defined at two sides thereof;
a cover engageable with the second portion, the cover having at least two rails formed at the two sides to engage with the sliding grooves correspondingly and a plurality of latches formed at an end thereof to correspondingly latch into the latching holes of the housing;
wherein the second portion forms at least one stopping slot, the cover forms at least one stopping body, the cover is attached on the second portion, the stopping body is slidably received in the stopping slot to retain the cover attaching with the housing.

15. The battery cover mechanism as claimed in claim 14, wherein the second portion includes a top wall, two sidewalls and an end wall, the top wall forms a receiving cavity, a first partition stage and a second partition stage at two sides of the receiving cavity, the first partition stage defines a first latching slot and two second latching slots, all the latching slots communicate with the receiving cavity and extend into the first portion.

16. The battery cover mechanism as claimed in claim 15, wherein the second partition stage forms an assembling slot and two stopping slots at two sides of the assembling slot, the assembling slot aligns with the first latching hole and communicates the receiving cavity to the end wall, the stopping slot correspondingly aligns with the second latching hole and extends to the receiving cavity.

17. The battery cover mechanism as claimed in claim 15, wherein the cover includes a first latch and two second latches, the first latch latches into the first latching slot, and the second latches correspondingly latch into the second latching slots.

18. The battery cover mechanism as claimed in claim 15, wherein the cover forms two stopping bodies aligned with the two second latches respectively, each stopping body is wedge shape.
